(19) United States
(12) Patent Application Publication
(10) Pub. No.: US 2024/0174855 A1
(43) Pub. Date: May 30, 2024

(54) Biodegradable Polyester Polymer and Easy-Tear Film Including the Same

(71) Applicants: SK Innovation Co., Ltd., Seoul (KR); SK Geo Centric Co., Ltd., Seoul (KR); Kolon Industries, Inc., Seoul (KR)

(72) Inventors: Jeong Sun KIM, Seoul (KR); Su Jin IM, Seoul (KR); Sung Won LEE, Daejeon (KR); Ki Yup KIM, Daejeon (KR); Do Young KIM, Daejeon (KR); Joo Hyun NAM, Daejeon (KR); Ji Hae PARK, Daejeon (KR)

(21) Appl. No.: 18/331,649

(22) Filed: Jun. 8, 2023

(30) Foreign Application Priority Data
Nov. 30, 2022 (KR) 10-2022-0164776

(51) Int. Cl. C08L 67/02; C08G 63/183; C08J 5/18

(52) U.S. Cl. CPC C08L 67/02; C08G 63/183; C08J 5/18; C08G 2230/00; C08J 2367/03; C08L 2201/06; C08L 2203/16

(57) ABSTRACT

Provided is a biodegradable polyester polymer comprising a polymerization reaction product of an aliphatic dicarboxylic acid, an C₆₋₃₀ aromatic dicarboxylic acid, an aliphatic diol, and a branching agent, and wherein the biodegradable polyester polymer has a ratio of z-average molecular weight (Mz) to weight average molecular weight (Mw) (“Mz/Mw”) greater than 2 and an easy-tear film including the same. The biodegradable film has excellent mechanical properties to effectively protect a product inside the packaging but also be easily opened in a controlled manner without excessive force and at the same time, provide an environmentally-friendly alternative to non-degradable plastics.

### CROSS-REFERENCE TO RELATED APPLICATIONS

This application claims priority under 35 U.S.C. § 119 to Korean Patent Application No. 10-2022-0164776, filed on Nov. 30, 2022, in the Korean Intellectual Property Office, the disclosure of which is incorporated herein by reference in its entirety.

### TECHNICAL FIELD

The following disclosure relates to a biodegradable polyester polymer and an easy-tear film including the same.

### BACKGROUND

Since a packaging material basically has the purpose of protecting products inside, it should be strong enough not to be easily broken or torn upon instantaneous shock. In this aspect, it may be said that a strong film has excellent physical properties, but when a packaging film such as a packaging film for food or a protective film which surrounds a product and should be essentially removed before use has strong physical properties, an excessive force is required to tear a film for product opening, which causes great inconvenience to consumers.

In order to solve the problem, a multilayer film in which a film having excellent tear resistance and a film having poor tear resistance are laminated was manufactured, thereby imparting tearability to a film, but no matter how thin the film having excellent tear resistance was made, the tear resistance of the entire multilayer film was not reduced, so that an effect of improving tearability to be desired was insignificant, and since the thickness of the multilayer became thick, it was difficult to substantially apply the film to a product.

Meanwhile, it is difficult to collect a conventional packaging material film, so that low recycling efficiency is shown, and the film has been recognized as the cause of polluting the environment due to its indiscreet use. In order to solve the problem, many companies are conducting research and development by replacing conventional general polymers with a biodegradable polymer to use as a packaging film, thereby lowering the environmental burden.

Therefore, the research and development of a degradable film which has excellent mechanical properties to effectively protect a product inside the packaging and may be easily opened in a controlled manner without an excessive force is needed.

### SUMMARY

The present disclosure provides a biodegradable polyester polymer having excellent tearability while having excellent mechanical properties, and a method of manufacturing the same.

The present disclosure also provides a biodegradable film manufactured using the biodegradable polyester polymer described above.

The present inventors have manufactured a biodegradable film having excellent tearability while having excellent mechanical properties, and as a result, found that when a weight average molecular weight (Mw) and a z-average molecular weight (Mz) satisfy certain ratios, tearability in one direction is significantly improved.

In one aspect, the present disclosure provides a biodegradable polyester polymer comprising a polymerization reaction product of a polymerizable composition comprising: an aliphatic dicarboxylic acid, an aromatic dicarboxylic acid, an aliphatic diol, and a branching agent, wherein the biodegradable polyester polymer satisfies Equation 1:

2<Mz/Mw [Equation 1]

wherein Mz is a z-average molecular weight, and Mw is a weight average molecular weight.

In one embodiment, the biodegradable polyester polymer may have a polydispersity index (PDI, Mw/Mn) of about 2.5 or more.

In one embodiment, the aliphatic dicarboxylic acid may be a C₂₋₂₀ aliphatic dicarboxylic acid. In one embodiment, the aliphatic dicarboxylic acid is succinic acid, adipic acid, sebacic acid, or a mixture of thereof.

In one embodiment, the aromatic dicarboxylic acid may be a C₆₋₃₀ aromatic dicarboxylic acid. In one embodiment, the aromatic dicarboxylic acid is phthalic acid, isophthalic acid, terephthalic acid, dimethyl phthalate, diethyl phthalate, dimethyl isophthalate, diethyl isophthalate, dimethyl terephthalate, diethyl terephthalate, or any combination of any of the foregoing.

In one embodiment, the aliphatic diol may be a C₂₋₂₀ aliphatic diol. In one embodiment, the reaction product is a reaction product of a composition comprising the aliphatic diol and the dicarboxylic acid component at a mole ratio of 1 to 3:1 (aliphatic diol:dicarboxylic acid component).

In one embodiment, the branching agent may be a polyol compound having 3 or more functional groups.

In one embodiment, the branching agent is tartaric acid, citric acid, malic acid, trimethylolpropane, trimethylolethane, pentaerythritol, polyether triol, glycerol, trimesic acid, trimellitic acid, trimellitic anhydride, pyromellitic acid, pyromellitic dianhydride, and any combination of the foregoing.

In one embodiment, the polymerizable composition comprises about 0.01 wt. % to about 2 wt. % of branching agent.

In one embodiment, the biodegradable polyester polymer may satisfy Equation 2: wherein Mz is a z-average molecular weight, and Mw is a weight average molecular weight.

In one embodiment, the biodegradable polyester polymer may have a z-average molecular weight of about 200,000 to about 1,000,000 g/mol.

In one embodiment, the biodegradable polyester polymer may have a number average molecular weight (Mn) of about 55,000 g/mol or less and a weight average molecular weight (Mw) of about 110,000 g/mol or more.

In one embodiment, the biodegradable polyester polymer may be polybutylene adipate terephthalate (PBAT), polybutylene succinate butylene terephthalate (PBAST), or polybutylene sebacate terephthalate (PBSeT).

In another aspect, the present disclosure provides a biodegradable film comprising the biodegradable polyester polymer described above.

In one embodiment, the biodegradable film may have a tear strength in a machine direction (MD) of about 2.5 g/μm or less under a thickness condition of 50 μm.

In one embodiment, the biodegradable film may have a tear strength in a transvers direction (TD) which is 5 times or more the tear strength in the MD direction.

In one embodiment, the biodegradable film may be used as a pharmaceutical packaging material, a food packaging material, a packaging film for product protection, a mulching film, or a shrink film.

Other features and aspects will be apparent from the following detailed description, the drawings, and the claims.

In another aspect the present disclosure provides a method of reducing white pollution resulting from and/or providing an environmentally-friendly method for the manufacture of a packaging film comprising molding a biodegradable polyester polymer into the packaging film, wherein the biodegradable polyester polymer comprises a polymerization reaction product of a polymerizable composition comprising: an aliphatic dicarboxylic acid, an aromatic dicarboxylic acid, an aliphatic diol, and a branching agent, wherein the biodegradable polyester polymer satisfies Equation 1:

2<Mz/Mw [Equation 1]

wherein Mz is a z-average molecular weight, and Mw is a weight average molecular weight.

### DETAILED DESCRIPTION OF EMBODIMENTS

Hereinafter, the present disclosure will be described in more detail. However, the following examples or exemplary embodiments are only a reference for describing the present disclosure in detail, and the present disclosure is not limited thereto and may be implemented in various forms.

Unless otherwise defined, all technical terms and scientific terms have the same meanings as those commonly understood by one of those skilled in the art to which the present disclosure pertains.

The terms used for description in the present specification are only for effectively describing a certain specific exemplary embodiment and are not intended to limit the present disclosure.

In addition, the singular form used in the specification and claims appended thereto may be intended to also include a plural form, unless otherwise indicated in the context.

Percentages used in the present specification without particular mention are based on weights, and as an example, a unit of % or ratio refers to a wt. % or a weight ratio and wt. % refers to wt. % of any one component in a total composition, unless otherwise defined.

In addition, unless explicitly described to the contrary, a part “comprising” a constituent element will be understood to imply further inclusion of other constituent elements rather than the exclusion of any other constituent elements.

In addition, the numerical ranges used in the present specification include all values within the range including the lower limit and the upper limit, increments logically derived in a form and span in a defined range, all double limited values, and all possible combinations of the upper limit and the lower limit in the numerical range defined in different forms. Unless otherwise particularly defined in the present specification, values which may be outside a numerical range due to experimental error or rounding off of a value are also included in the defined numerical range.

The term “about” means within 20%, within 15%, within 10%, within 9%, within 8%, within 7%, within 6%, within 5%, within 4%, within 3%, within 2%, within 1%, or less variation of a given value or range. When used to describe a temperature, the term “about” means with 5° (i.e., ±5°) of that recited temperature.

Hereinafter, the present disclosure will be described in more detail.

The present disclosure provides a biodegradable polyester polymer comprising a polymerization product of an aliphatic dicarboxylic acid, an aromatic dicarboxylic acid, an aliphatic diol, and a branching agent, wherein the biodegradable polyester polymer satisfies Equation 1:

2<Mz/Mw [Equation 1].

In other words, in one embodiment, the biodegradable polyester polymer has a ratio of z-average molecular weight to weight average molecular weight greater than 2.

In one embodiment, the biodegradable polyester polymer may satisfy one or more of Equations 2, 3, and 4:

2<Mz/Mw<15 [Equation 2]

2<Mz/Mw<5 [Equation 3]

2.5<Mz/Mw<4 [Equation 4].

In Equations 1, 2, 3, and 4, Mz is a z-average molecular weight and Mw is a weight average molecular weight.

When a biodegradable polyester polymer satisfying Equation 1, or more specifically Equation 2, 3, or 4 is molded into a film or a sheet, the tear strength of the film or sheet in one direction is significantly lower than the tear strength in another direction, and thus, may display overall high mechanical strength but yet be easily torn, if force is applied in a specific direction, so as to provide easy-tear packaging.

Additionally, a polyester polymer prepared from polymerization of an aliphatic diol and aliphatic and aromatic dicarboxylic acids can be broken down into constituent parts through enzymatic degradation (e.g., esterases, proteases) to provide a climate-friendly alternative to commonly used non-biodegradable polymers. By utilizing the biodegradable polymers as disclosed herein, e.g., in packaging, negative effects of non-degradable plastics (“white pollution”) on the environment may be mitigated, where the long-term release of waste products into the environment is materially reduced. Further, the diols and dicarboxylic acids used in the preparation of the biodegradable polyester polymers disclosed herein are not sourced from petroleum products. As such, the biodegradable polyester polymers and the films prepared therefrom also reduce dependence of plastics manufacturing on fossil resources.

A biodegradable polyester polymer, as disclosed herein, may be prepared by contacting a polymerizable composition comprising (1) a dicarboxylic acid component comprising (a) an aliphatic dicarboxylic acid and (b) an aromatic dicarboxylic acid; (2) an aliphatic diol; and (3) a branching agent under conditions effective to polymerize the aliphatic dicarboxylic acid, aromatic dicarboxylic acid, and aliphatic diol thereby forming the biodegradable polyester polymer. Polymerization may be carried out according to any method known in the art, such as, but not limited to, a continuous or a batchwise polymerization method.

In one embodiment, the aliphatic dicarboxylic acid may be a C₂₋₄₀ aliphatic dicarboxylic acid, or specifically, the aliphatic dicarboxylic acid may be a C₂₋₂₀ aliphatic dicarboxylic acid, or as an example, one or a combination of two or more selected from the group consisting of oxalic acid, malonic acid, succinic acid, glutaric acid, adipic acid, pimelic acid, sebacic acid, fumaric acid, azelaic acid, itaconic acid, 1,9-nonanedicarboxylic acid, 1,10-decanedicarboxylic acid, dimeric fatty acids, their anhydride derivatives, and the like, and more specifically, may be succinic acid, adipic acid, sebacic acid, or a mixture of thereof.

In one embodiment, the aromatic dicarboxylic acid may be a C₆₋₅₀ aromatic dicarboxylic acid. In one embodiment, the aromatic dicarboxylic acid is a C₆₋₅₀ aromatic dicarboxylic acid, or as an example, may be one or a combination of two or more selected from the group consisting of phthalic acid, isophthalic acid, terephthalic acid, dimethyl phthalate, diethyl phthalate, dimethyl isophthalate, diethyl isophthalate, dimethyl terephthalate, diethyl terephthalate, and the like.

In one embodiment, the aliphatic dicarboxylic acid and the aromatic dicarboxylic acid are polymerized at a mole ratio of 1 to 9:9 to 1 (aliphatic dicarboxylic acid:aromatic dicarboxylic acid), or specifically 3 to 7:7 to 3, but is not limited thereto.

In one embodiment, the aliphatic diol may be a C₂₋₂₀ aliphatic diol, or specifically a C₂₋₁₅ aliphatic diol, or as an example, may be one or a combination of two or more selected from the group consisting of ethylene glycol, propylene glycol, neopentyl glycol, 1,3-propanediol, 1,4-butanediol, 1,5-pentanediol, 1,6-hexanediol, 1,2-octanediol, 1,6-octanediol, 1,9-nonanediol, 1,2-decanediol, 1,10-decanediol, and the like, and more specifically, may be one or a combination of two or more selected from the group consisting of ethylene glycol, propylene glycol, 1,3-propanediol, 1,4-butanediol, 1,6-hexanediol, and the like.

In one embodiment, the aliphatic diol and the dicarboxylic acid component are polymerized at a mole ratio of 1 to 3:1 (aliphatic diol:dicarboxylic acid component), or specifically at a mole ratio of 1.2 to 2.5:1.

A branching agent may be used to adjust a molecular weight distribution of the biodegradable polyester polymer to be large, e.g., to adjust the Mz of the biodegradable polyester polymer to satisfy Equation 1. Branching agents suitable for use as disclosed herein may have 3 or more functional groups. In one embodiment, the branching agent may be a polyol compound having 3 or more hydroxyl groups. More specifically, the branching agent may be a polyol compound having 4 or more hydroxyl groups. The branching agent may be one or a combination of two or more selected from the group consisting of tartaric acid, citric acid, malic acid, trimethylolpropane, trimethylolethane, pentaerythritol, polyether triol, glycerol, trimesic acid, trimellitic acid, trimellitic anhydride, pyromellitic acid, pyromellitic dianhydride, and the like, or more specifically, may be glycerol or pentaerythritol.

The branching agent may be included in the polymerizable composition at a weight percent (wt. %) of about 0.01 wt. % to about 2 wt. %, or about 0.05 wt. % to about 1 wt. %, or about 0.1 wt. % to about 0.5 wt. % with respect to the weight of the polymerizable composition.

Conditions effective to polymerize the aliphatic dicarboxylic acid, aromatic dicarboxylic acid, and aliphatic diol may include, without limitation, elevated temperature, reduced pressure, use of one or more stabilizers, use of a catalyst, or any combination thereof. In one embodiment, a stabilizer is used to make a polymerization reaction product. In one embodiment, a citric acid chelate-based titanium compound is used. In one embodiment, a phosphorus-based stabilizer, such as phosphorous acid, is used. In one embodiment, a citric acid chelate-based titanium compound and a phosphorus-based stabilizer is used. In one embodiment, the polymerizable composition is subjected to an elevated temperature of about 200° C. to about 250° C. In one embodiment, the polymerizable composition is subjected to an elevated temperature of about 230° C. to about 240° C. In one embodiment, a polycondensation catalyst is used. In one embodiment, the polycondensation catalyst is tetrabutyl titanate.

In one embodiment, the biodegradable polyester polymer may have a number average molecular weight (Mn) of about 100,000 g/mol or less, or about 55,000 g/mol or lessor more specifically about 30,000 g/mol to about 55,000 g/mol.

In one embodiment, the biodegradable polyester polymer may have a weight average molecular weight (Mw) of 100,000 g/mol or more, specifically about 110,000 g/mol or more, or more specifically about 120,000 g/mol to about 200,000 g/mol.

In one embodiment, the biodegradable polyester polymer may have a z-average molecular weight (Mz) of about 300,000 g/mol to about 5,000,000 g/mol, specifically about 200,000 g/mol to about 1,000,000 g/mol or more specifically about 250,000 g/mol to about 800,000 g/mol.

In one embodiment, the biodegradable polyester polymer may have a polydispersity index (PDI, Mw/Mn) of about 2.2 or more, about 2.5 or more, specifically about 2.5 to about 10, or more specifically about 2.5 to about 7.

When a biodegradable polyester polymer has the properties as describe herein (e.g., Mn, Mw, Mz, PDI), a biodegradable film prepared therefrom may display a significant difference between tear strengths in the transverse direction (TD) and machine direction (MD) and therefore be widely applied to manufacture of easy-tear packaging.

In one embodiment, the biodegradable polyester polymer as described herein may be polybutylene adipate terephthalate (PBAT), polybutylene succinate butylene terephthalate (PBAST), or polybutylene sebacate terephthalate (PBSeT).

In another aspect, the present disclosure provides a biodegradable film comprising the biodegradable polyester polymer described above. The thickness of the biodegradable film is not particularly limited and may be adjusted based on intended use. In one embodiment, the biodegradable film may have a thickness of about 1 μm to about 500 μm, specifically about 10 μm to about 200 μm, but is not limited thereto. The biodegradable film may be prepared by any common and known film processing methods, such as, but not limited to, casting, extrusion, bubble blowing, calendering, sintering, and the like. The biodegradable film comprising the biodegradable polyester polymer disclosed may be stretched in one direction, and the stretching direction is referred to as a machine direction (MD) and a direction perpendicular to the stretching direction is referred to as a transverse direction (TD), and the mechanical properties such as tensile strength and tear strength measured in the TD direction and the MD direction of the biodegradable film may be different from each other. In one embodiment, the mechanical properties of the biodegradable film, such as tensile or tear strength, in the TD direction are higher than the mechanical properties in the MD direction. In one embodiment, the mechanical properties in the TD direction, such as tensile or tear strength, of the biodegradable film are at least 2 times, at least 3 times, at least 4 times, or at least 5 times or more higher than the mechanical property in the MD direction of the biodegradable film.

For example, in one embodiment, a biodegradable film comprising a biodegradable polyester polymer as disclosed herein may have a tear strength in the MD direction of about 3.0 g/μm or less, specifically about 2.5 g/μm or less, or more specifically about 0.2 g/μm to about 1.5 g/μm. In one embodiment, the tear strength is measured in a film under a thickness of condition of 50±2 μm. In one embodiment, the tear strength of the biodegradable film prepared from the biodegradable polyester polymer disclosed herein in the TD direction may be about 5.0 g/μm or more, specifically about 8.0 g/μm or more, or more specifically about 9.0 g/μm to about 25.0 g/μm.

In one embodiment, a biodegradable film prepared from a biodegradable polyester polymer as disclosed herein may have the tear strength in the TD direction, which is 5 times or more, specifically 10 times or more, or more specifically 12 times or more than the tear strength in the MD direction. In one embodiment, the biodegradable film prepared from the biodegradable polyester polymer disclosed herein may have the TD tear strength that is not more than 30 times greater than the MD tear strength. The biodegradable film may exhibit easy-tear properties due to the significant difference in the MD and TD tear strengths.

Biodegradable films prepared from the biodegradable polyester polymer disclosed herein may be widely used for packaging, such as for a pharmaceutical packaging material, a food packaging material, a packaging film for product protection, a mulching film, or a shrink film.

Hereinafter, the present disclosure will be described in more detail with reference to the examples and the comparative examples. However, the following examples and the comparative examples are only an example for describing the present disclosure in more detail, and do not limit the present disclosure in any way.

### EXAMPLES

The physical properties of the following examples and comparative examples were measured by the following methods.

### Method of Evaluating Physical Properties

1. Molecular Weight (Mw, Mn, and Mz) [g/Mol]

A weight average molecular weight (Mw), a number average molecular weight (Mn), and a z-average molecular weight (Mz) were measured using GPC (Alliance HPLC, Waters). Tetrahydrofuran as a solvent and polystyrene (EasiCal Polystyrene, Pre-prepared Calibration Kits) as a standard were used, and the analysis was performed at an operating temperature of 35° C. and a flow rate of 1 mL/min.

Other specific conditions for measuring a molecular weight are as follows:

Analytical instrument: a GPC system (model name: Agilent, 1260 Infinity II High-Temperature GPC System) in which two columns (model name: Agilent, PLGEL MIXED-C 7.5×300 mm, 5 μm) were connected, a GPC flow rate was set to 1 mL/min, and a refractive index detector was connected was used.

Sample preparation: 1.5 mg of a sample and 1 ml of tetrahydrofuran were added to a vial and stirring was performed at room temperature for 1 hour or more by a shaking mixer for dissolving. 100 μL of the thus-prepared solution was injected into the GPC. Mn, Mw, and Mz are defined as follows:

$${M}_{n} = \frac{\sum {N}_{i} {M}_{i}}{\sum {N}_{i}} \qquad {M}_{w} = \frac{\sum {N}_{i} {M}_{i}^{2}}{\sum {N}_{i} {M}_{i}} \qquad {M}_{z} = \frac{\sum {N}_{i} {M}_{i}^{3}}{\sum {N}_{i} {M}_{i}^{2}}$$

wherein Mᵢ is a molecular weight of a molecule, and Nᵢ is the number of molecules having a molecular weight of Mᵢ. Polydispersity index (PDI) was calculated from Mw and Mn.

### 2. Tear Strength

The thus-prepared biodegradable polyester polymers were each manufactured into a film having a thickness of 50 μm and the Elmendorf tear strength was measured in accordance with ASTM D1992. Specifically, the conditions of a temperature of 23° C., a relative humidity of 50%, and the tear strength in a length direction and the tear strength in a width direction of the film are shown in Table 1 as a MD tear strength and a TD tear strength, respectively.

### Examples 1 to 6 and Comparative Examples 1 and 2

6780 g of 1,4-butanediol, 3950 g of terephthalic acid, and 3850 g of adipic acid were combined, and 16 g of an aqueous solution of a citric acid chelate-based titanium compound was added. The reaction temperature (1) was heated up to 230° C. and 6.0 g of a phosphorous acid as a phosphorus-based stabilizer was added. The reaction was performed for 3 hours while a reaction tube was maintained at normal pressure and water was removed with a rectifying tower, thereby preparing an oligomer.

Thereafter, a branching agent was added according to the type and the content listed in Table 1 and 10 g of tetrabutyl titanate as a polycondensation catalyst was added. The pressure in the reaction tube was lowered stepwise to 1 torr or less while the reaction temperature (2) was raised to 240° C. for 1 hour and excessive 1,4-butanediol was removed by distillation. The reaction was terminated when a discharge load was reached, the polyester was pelletized using an underwater pelletizer, and dried to obtain a biodegradable polyester polymer. The Mn, Mw, and Mz of each biodegradable polyester polymer was measured and is shown in Table 1. Table 1 also reports PDI as Mz/Mw of each of the biodegradable polyester polymers.

The obtained biodegradable polyester polymer was extruded on a single sheet extruder and manufactured into a 50 μm film. The physical properties of the thus-manufactured film were measured and are shown in the following Table 2.

TABLE 1

| | | Branching | | | | | |
|---|---|---|---|---|---|---|---|
| | Branching | Agent | Mn | Mw | Mz | PDI | Mz/ |
| | Agent | Content | [g/mol] | [g/mol] | [g/mol] | (Mw/Mn) | Mw |
| Example 1 | Glycerol | 14.5 g | 50,245 | 132,840 | 274,560 | 2.6 | 2.1 |
| | | (1,000 ppm) | | | | | |
| Example 2 | Glycerol | 21.8 g | 47,693 | 122,980 | 265,270 | 2.6 | 2.2 |
| | | (1,500 ppm) | | | | | |
| Example 3 | Glycerol | 29 g | 46,000 | 141,000 | 395,000 | 3.1 | 2.8 |
| | | (2,000 ppm) | | | | | |
| Example 4 | Pentaerythritol | 14.5 g | 51,832 | 145,620 | 403,970 | 2.8 | 2.8 |
| | | (1,000 ppm) | | | | | |
| Example 5 | Pentaerythritol | 21.8 g | 42,804 | 152,880 | 539,560 | 3.6 | 3.5 |
| | | (1,500 ppm) | | | | | |
| Example 6 | Pentaerythritol | 29 g | 33,471 | 142,280 | 560,760 | 4.3 | 3.9 |
| | | (2,000 ppm) | | | | | |
| Comparative | Glycerol | 7 g | 59,100 | 117,300 | 203,600 | 2.0 | 1.7 |
| Example 1 | | (500 ppm) | | | | | |
| Comparative | Pentaerythritol | 7 g | 51,322 | 108,800 | 210,400 | 2.1 | 1.9 |
| Example 2 | | (500 ppm) | | | | | |

TABLE 2

| | MD tear strength | TD tear strength | TD/MD |
|---|---|---|---|
| | [g/μm] | [g/μm] | (times) |
| Example 1 | 2.1 | 17.6 | 8.4 |
| Example 2 | 1.4 | 16.0 | 11.4 |
| Example 3 | 1.2 | 14.7 | 12.3 |
| Example 4 | 1.9 | 12.5 | 6.6 |
| Example 5 | 0.9 | 11.1 | 12.3 |
| Example 6 | 0.8 | 9.6 | 12.0 |
| Comparative Example 1 | 3.0 | 11.8 | 3.9 |
| Comparative Example 2 | 2.8 | 12.7 | 4.5 |

As seen from Tables 1 and 2, the biodegradable polyester polymer of Example 5 had an Mz/Mw of 3.5, an MD tear strength of 0.9 g/μm, and a TD tear strength of 11.1 g/μm. It was confirmed that since the TD tear strength was about 12 times greater than the MD tear strength, easy-tearing, which is a characteristic of being easily torn in one direction, may be effectively implemented. In contrast, in Comparative Examples 1 and 2, Mz/Mw was less than 2.0. The TD tear strength was about 4 times less than the MD tear strength in Comparative Example 1 and about 4.5 times less than the MD tear strength in Comparative Example 2, resulting in at least a 10-fold decline in physical properties.

In summary, the present disclosure provides biodegradable polyester polymers having excellent tearability in one direction while having overall excellent mechanical properties, and a biodegradable film comprising the same. A biodegradable polyester polymer having a TD tear strength that is 5 times or more than its MD tear strength shows excellent tear resistance in one direction and excellent tearability in the other direction. In addition, the biodegradable film manufactured using the polymer may be easily opened in a controlled manner without an excessive force while effectively protecting a product inside the packaging.

Hereinabove, although the present invention has been described by specific matters and limited exemplary embodiments, they have been provided only for assisting in the entire understanding of the present invention, and the present invention is not limited to the exemplary embodiments. Various modifications and changes may be made by those skilled in the art to which the present invention pertains from this description.

Therefore, the spirit of the present invention should not be limited to the above-described exemplary embodiments, and the following claims as well as all modified equally or equivalently to the claims are intended to fall within the scope and spirit of the invention.

1-15. (canceled)

16. A biodegradable film comprising a biodegradable polyester polymer, wherein the biodegradable polyester polymer comprises a polymerization reaction product of an aliphatic dicarboxylic acid, an aromatic dicarboxylic acid, an aliphatic diol, and a branching agent, wherein the biodegradable polyester polymer has a ratio of z-average molecular weight (Mz) to weight average molecular weight (Mw) (“Mz/Mw”) greater than 2, wherein the aromatic dicarboxylic acid is a C₆₋₃₀ aromatic dicarboxylic acid, and wherein the biodegradable polyester polymer has an Mz of about 250,000 g/mol to about 1,000,000 g/mol.

17. The biodegradable film of claim 16, wherein the biodegradable film has a machine direction (MD) tear strength of about 2.5 g/μm or less.

18. The biodegradable film of claim 16, wherein the biodegradable film has a transverse direction (TD) tear strength that is 5 times or more the MD tear strength.

19. A pharmaceutical packaging material, a food packaging material, a packaging film for product protection, a mulching film, or a shrink film comprising the biodegradable film of claim 16.

20. (canceled)

21. The biodegradable film of claim 16, wherein the biodegradable polyester polymer has a polydispersity index of about 2.5 or more.

22. The biodegradable film of claim 16, wherein the branching agent is a polyol compound having 3 or more functional groups.

23. The biodegradable film of claim 16, wherein the polymerizable composition comprises about 0.01 wt. % to about 2 wt. % of the branching agent.

24. (canceled)

25. The biodegradable film of claim 16, wherein the biodegradable polyester polymer is polybutylene adipate terephthalate (PBAT), polybutylene succinate butylene terephthalate (PBAST), or polybutylene sebacate terephthalate (PBSeT).

26. The biodegradable film of claim 16, wherein the aliphatic dicarboxylic acid is adipic acid.

27. The biodegradable film of claim 16, wherein the aromatic dicarboxylic acid is terephthalic acid.

28. The biodegradable film of claim 16, wherein the aliphatic diol is 1,4-butanediol.

29. The biodegradable film of claim 16, wherein the branching agent is pentaerythritol.

30. The biodegradable film of claim 16, wherein the aromatic dicarboxylic acid is phthalic acid, isophthalic acid, terephthalic acid, dimethyl phthalate, diethyl phthalate, dimethyl isophthalate, diethyl isophthalate, dimethyl terephthalate, diethyl terephthalate, or any combination of any of the foregoing.

31. The biodegradable polyester polymer of claim 16, wherein the biodegradable polyester polymer has an Mz/Mw of greater than 2 to 15.

32. The biodegradable film of claim 16, wherein the biodegradable polyester polymer has an Mz of about 250,000 g/mol to about 800,000 g/mol.
